(19) United States
(12) Patent Application Publication
(10) Pub. No.: US 2016/0257024 A1
(43) Pub. Date: Sep. 8, 2016

(54) IMPRINTING MOLD AND THE MANUFACTURING METHOD THEREOF

(71) Applicant: NATIONAL TAIWAN UNIVERSITY OF SCIENCE AND TECHNOLOGY, Taipei (TW)

(72) Inventors: Jeng-Ywan Jeng, Taipei (TW); Pei-Ying Wu, Taipei (TW); Kuo-Hsiang Tu, Taipei (TW)

(21) Appl. No.: 14/921,947

(22) Filed: Oct. 23, 2015

(30) Foreign Application Priority Data
Mar. 2, 2015 (TW) 104106549

(51) Int. Cl. B28B 11/10; B28B 7/36; B28B 7/34; C23C 30/00

(52) U.S. Cl. CPC B28B 11/10; C23C 30/005; B28B 7/36; B28B 7/346

(57) ABSTRACT

A method of manufacturing an imprinting mold is provided. The method includes steps of providing a supporting substrate; forming a conductive metal layer on the supporting substrate; polishing the conductive metal layer to form a polished surface; and treating the polished surface to form a plurality of microstructures.

### CROSS-REFERENCE TO RELATED APPLICATION AND CLAIM OF PRIORITY

The application claims the benefits of the Taiwan Patent Application No. 104106549 filed on Mar. 2, 2015 in the Taiwan Intellectual Property Office, the disclosures of which are incorporated herein in their entirety by reference.

### FIELD OF THE INVENTION

The present invention relates to an imprinting mold and the manufacturing method thereof, and more particularly to an imprinting mold having a plurality of microstructures and the manufacturing method thereof.

### BACKGROUND OF THE INVENTION

Conventional patterning technologies all use or change the photolithography process in traditional semiconductor manufacturing processes, and the exposure is performed by a stepper to shrink and transfer patterns on the mask to generate 2.5D patterning microstructures. However, the structure formed on the substrate by the photolithography process is straight line-shaped, and related to the lattice direction of the material. Therefore, the above technology cannot achieve the finer and low-cost periodical micro/nano structure process technology required by the industry, e.g. the crystal growth for the gallium nitride (GaN).

The gallium nitride can be used for high-power and high-speed photoelectric elements, and has an important application for Blu-ray, ultraviolet, violet and other light-emitting diodes as well as laser diodes. In order to reduce the manufacturing cost of the gallium nitride, the crystal growth for the gallium nitride is performed on the silicon substrate. The silicon substrate has a large size, a good electric conductivity, a good thermal conductivity and a good thermal stability, and is low-cost and easy to be processed. However, there is a thermal expansion coefficient difference between the gallium nitride and the silicon substrate. This causes the gallium nitride chip to be bent and cracked due to large tension and stress during the cooling process for the gallium nitride epitaxial film after the end of the growth therefor, thereby reducing the yield of elements. The most important solution for the thermal expansion coefficient difference between the gallium nitride and the silicon substrate is the patterning technology for micro/nano structures.

In order to overcome the drawbacks in the prior art, an imprinting mold and the manufacturing method thereof are provided. The particular design in the present invention not only solves the problems described above, but also is easy to be implemented. Thus, the present invention has the utility for the industry.

### SUMMARY OF THE INVENTION

The imprinting mold and the manufacturing method thereof of the present invention are suitable for the nano imprinting and the electrochemical processing method for mass production of the substrate having a plurality of microstructures, and have the advantages of high productivity and a low cost. In addition, the imprinting mold of the present invention can be applied to various substrates with different materials, e.g. the silicon substrate, the glass substrate, the plastic substrate, the sapphire substrate or other substrates used by the light-emitting diode industry.

In accordance with an aspect of the present invention, a method of manufacturing an imprinting mold is provided. The method includes steps of providing a supporting substrate; forming a conductive metal layer on the supporting substrate; polishing the conductive metal layer to form a polished surface; and treating the polished surface to form a plurality of microstructures.

According to the above aspect, the method further includes steps of providing a supporting material; processing the supporting material to form a processed material having a predetermined shape; and thermally treating the processed material to form the supporting substrate.

According to the above aspect, the supporting substrate has a material being one selected from a group consisting of a stainless steel, a mold steel, a carbon steel and an amorphous metal.

According to the above aspect, the conductive metal layer has a material being a nickel.

According to the above aspect, the conductive metal layer has a material being a copper.

According to the above aspect, the microstructures are formed by at least one selected from a group consisting of a computer numerical control (CNC) machine, a focused ion beam (FIB), an electron beam, an x-ray and a laser.

In accordance with another aspect of the present invention, an imprinting mold is provided. The imprinting mold includes a supporting substrate; a conductive metal layer disposed on the supporting substrate; and a plurality of microstructures formed on the conductive metal layer.

According to the above aspect, the microstructures and the conductive metal layer are formed integrally with one another.

According to the above aspect, the microstructures and the conductive metal layer are formed separately.

According to the above aspect, the supporting substrate has a material being one selected from a group consisting of a stainless steel, a mold steel, a carbon steel and an amorphous metal.

According to the above aspect, the conductive metal layer has a material being one of a nickel and a copper.

According to the above aspect, the microstructures are formed by at least one selected from a group consisting of a computer numerical control machine, a focus ion beam, an electron beam, an x-ray and a laser.

In accordance with a further aspect of the present invention, an imprinting mold is provided. The imprinting mold includes a supporting substrate having a working surface; and a plurality of microstructures formed on the working surface and connected to each other.

According to the above aspect, the supporting substrate has a material being one selected from a group consisting of a stainless steel, a mold steel, a carbon steel and an amorphous metal.

According to the above aspect, the conductive metal layer has a material being one of a nickel and a copper.

According to the above aspect, the microstructures are formed by at least one selected from a group consisting of a computer numerical control machine, a focus ion beam, an electron beam, an x-ray and a laser.

In accordance with further another aspect of the present invention, an imprinting mold is provided. The imprinting mold includes a rigid supporting substrate having a working surface; and a plurality of microstructures formed on the working surface and performing an imprinting.

According to the above aspect, the supporting substrate has a material being one selected from a group consisting of a stainless steel, a mold steel, a carbon steel and an amorphous metal.

According to the above aspect, the conductive metal layer has a material being one of a nickel and a copper.

According to the above aspect, the microstructures are formed by at least one selected from a group consisting of a computer numerical control machine, a focus ion beam, an electron beam, an x-ray and a laser.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a flowchart for manufacturing an imprinting mold according to an embodiment of the present invention;

FIG. 2 shows a supporting substrate according to an embodiment of the present invention;

FIG. 3 shows a flowchart for processing the supporting substrate in FIG. 2 according to an embodiment of the present invention;

FIG. 4 shows a knife according to an embodiment of the present invention;

FIG. 5 is a plane view of an imprinting mold formed by the knife in FIG. 4 according to an embodiment of the present invention;

FIG. 6 is a top view of the microstructures within the matrix area B in FIG. 5;

FIG. 7 is top view of microstructures within a one-way area A at the upper side in FIG. 5; and

FIG. 8 is a partial cross-sectional view of microstructures in FIG. 6.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

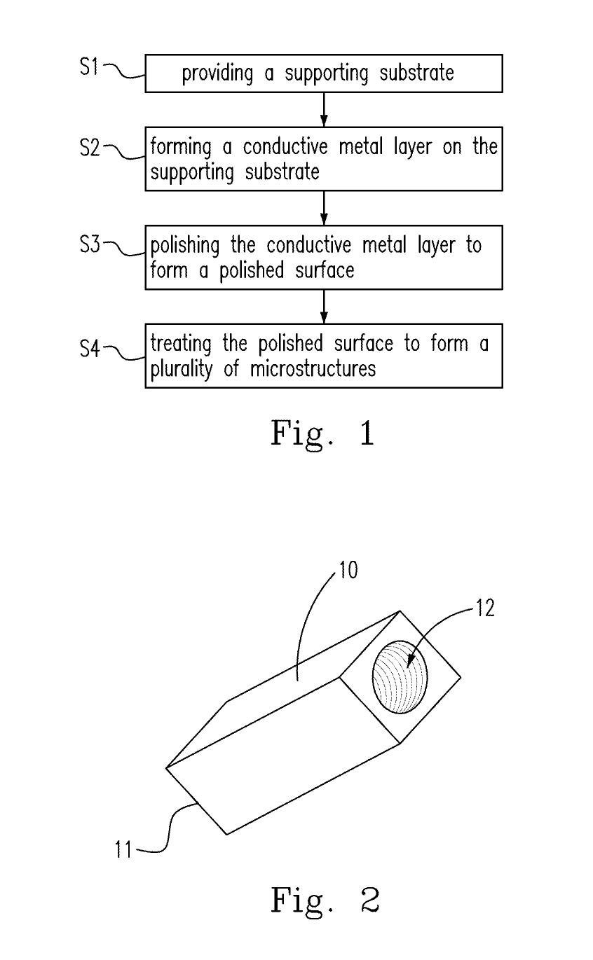

Please refer to FIG. 1, which shows a flowchart for manufacturing an imprinting mold according to an embodiment of the present invention. First, a supporting substrate is provided (step S1). Next, a conductive metal layer is formed on the supporting substrate (step S2). Then, the conductive metal layer is polished to form a polished surface (step S3). Finally, the polished surface is treated to form a plurality of microstructures (step S4).

Material selection and the detailed step description for each step will be described one by one with reference to the following figures.

Regarding the selection of the material of the supporting substrate in the step S1, it depends on what follow-up process is performed to imprint the microstructures to the substrate. For example, the follow-up process is an electrochemical processing process, an impression process, etc. Take the impression process as an example. The supporting substrate must have rigidity so that it can provide a certain supporting force in the impression process. Therefore, when performing the impression process, the supporting substrate can support the conductive metal layer having the microstructures so that the conductive metal layer having the microstructures is not deformed due to power reception, thereby achieving a precise imprinting effect. Take the electrochemical processing process as an example, the supporting substrate must be more anti-corrosion. When performing the electrochemical processing process, the imprinting mold and the substrate are placed in the chemical etching solution. In this case, the anti-corrosion supporting substrate would not be eroded by the chemical etching solution. According to an embodiment of the present invention, the material of the supporting substrate can be the stainless steel, the mold steel, the carbon steel or the amorphous metal. The above materials all have a better rigidity and anti-corrosion property so that when performing the follow-up imprinting, they provide good support and are not prone to erosion of the chemical etching solution.

Please refer to FIG. 2, which shows a supporting substrate 10 according to an embodiment of the present invention. The shape of the supporting substrate 10 is columnar. Besides columnar, the shape of the supporting substrate 10 can also be cylindrical, taper, flat, etc. On the premise that suitable support can be provided, the shape of the supporting substrate 10 does not influence the effect to be achieved by the present invention. The supporting substrate 10 has a first side having a screw hole 12. The inner side of the screw hole 12 has threads. An opening of the screw hole 12 is located on the surface of the first side of the supporting substrate 10. A corresponding screw can be screwed via the opening so that the supporting substrate 10 is locked on the screw. The supporting substrate 10 has a second side opposite to the first side. A conductive layer is formed on a working surface 11 of the second side. Through the design of the above screw hole 12, the supporting substrate 10 can be assembled on the machine, and is convenient to be dissembled and assembled. Therefore, the imprinting mold of the present invention can be repeatedly used for many times. In addition, through the assistance of the machine, the accuracy of the imprinting can also be ensured.

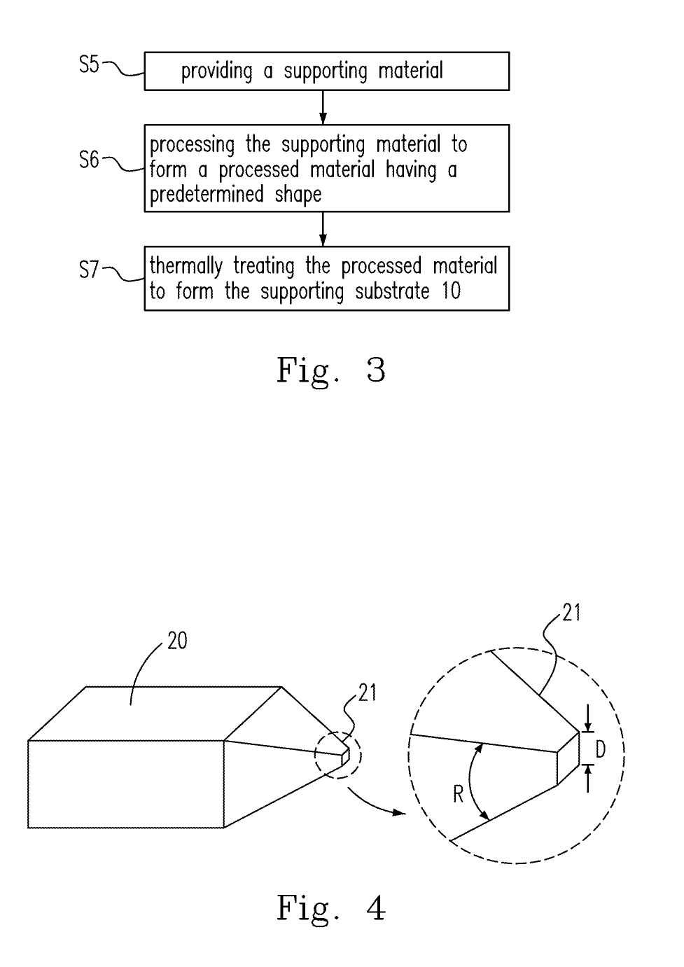

Please refer to FIG. 3, which shows a flowchart for processing the supporting substrate 10 in FIG. 2 according to an embodiment of the present invention. First, a supporting material is provided (step S5). The supporting material can be the stainless steel, the mold steel, the carbon steel or the amorphous metal as described above. Next, the supporting material is processed to form a processed material having a predetermined shape (step S6). Regarding processing the supporting material in the step S6, according to an embodiment of the present invention, a drill with a diameter of 4 mm is used to drill the supporting material to form a recess having a sufficient depth. Then, a screw tap with a tapping aperture of 4.1˜4.2 mm is used to tap the recess so that threads are formed on the inner surface of the recess, thereby achieving a screw hole with a diameter of 4 mm. Finally, the processed material is thermally treated (e.g. annealing) to form the supporting substrate 10 (step S7). Because the supporting material is processed, residual stresses are generated inside the supporting material. This influences the accuracy of the microstructures (micro/nano patterning structures) subsequently formed on the supporting material. Therefore, the thermal treatment in the step S7 can be performed for the processed supporting material to eliminate inside stresses. The supporting substrate 10 formed will have the advantage of increasing the accuracy of the micro/nano patterning structures. According to an embodiment of the present invention, the thermally treated supporting substrate 10 can be further polished to smooth the position where the conductive metal layer is to be formed to form a polished surface. Therefore, the conductive metal layer formed on the polished surface can have a more uniform thickness. This enhances the accuracy of the micro-nano patterning structures.

Regarding the selection of the material of the conductive metal layer in the step S2, the material having a good anti-corrosion property and a good ductility is preferred. According to an embodiment of the present invention, the material of the conductive metal layer is nickel. The thickness of the nickel layer after grinding and polishing is preferably below 150 μm, and more preferably 120 μm to 150 μm. According to an embodiment of the present invention, the material of the substrate is copper. Copper has a good electrical conductivity and a good heat dissipating property, which helps to accelerate the imprinting rate when performing the imprinting by electrochemical etching. When the conductive metal layer is nickel, an electroless nickel plating process can be used to form nickel on the supporting substrate 10 to obtain a uniform film thickness. The electroless nickel plating process includes steps of multiple washing→activation→spraying→multiple washing→acceleration→washing→electroless copper plating→spraying→multiple washing→activation→multiple washing→electroless nickel plating→spraying→multiple washing→passivation→spraying→multiple washing→pure water→dehydration→drying→check. Regarding the nickel layer formed, according to the step S3, it can be polished or grinded and polished to form a polished surface with a good flatness. This avoids the error in height or precision of the microstructures during the subsequent imprinting of the microstructures to a substrate.

Then, according to the step S4, the polished surface is treated to form the microstructures. For example, the microstructures are formed on the conductive metal layer by at least one selected from a group consisting of a computer numerical control (CNC) machine, a focused ion beam (FIB), an electron beam, an x-ray and a laser. Different surface treating manners for the polished surface can provide microstructures with different sizes. For example, the 0.1 μm microstructure or larger can be manufactured by the CNC machine, 0.1 μm to 0.01 μm microstructures can be manufactured by the electron beam, and the 0.01 μm microstructure or smaller can be manufactured by the x-ray. The CNC machine is taken as an example for illustration as follows.

Please refer to FIG. 4, which shows a knife 20 according to an embodiment of the present invention. The super-precise fine processing machine uses the knife 20 to cut the conductive metal layer to form the microstructures thereon. For example, the super-precise fine processing machine cuts the polished surface of the conductive metal layer to form a remaining portion of the conductive metal layer. The remaining portion is disposed on the supporting substrate, and the microstructures are formed on the remaining portion. The portion of the knife 20 for cutting can be V-shaped, curved, non-spherical, etc., depending on the shape of the microstructures to be formed. For example, when a micro-lens in an image optical element is to be formed, the knife 20 can be used to form the microstructures corresponding to a plurality of micro-lenses on the conductive metal layer first, and then the microstructures are imprinted to a glass substrate or a plastic substrate to form the micro-lenses. Therefore, the microstructures formed on the conductive metal layer of the present invention not only can form 2D/2.5D structures like the lithography exposure process can, but also avoids the limitation in the lithography exposure process with respect to the straight line, lattice direction and so on to form curved microstructures, polyhedral microstructures, etc. Thus, the present invention can form true 3D microstructures.

According to an embodiment of the present invention, the knife 20 is a diamond knife. The knife 20 has a point 21. The point 21 has a plane and an included angle R. The width D of the plane of the point 21 depends on the spacing between the microstructures formed, and the included angle R depends on the included angle and height of the microstructure itself. Take the silicon substrate on which the gallium nitride is grown as an example, wherein the width D of the plane of the point 21 is preferably 0.6 μm, and the included angle R is preferably 61.97 degrees.

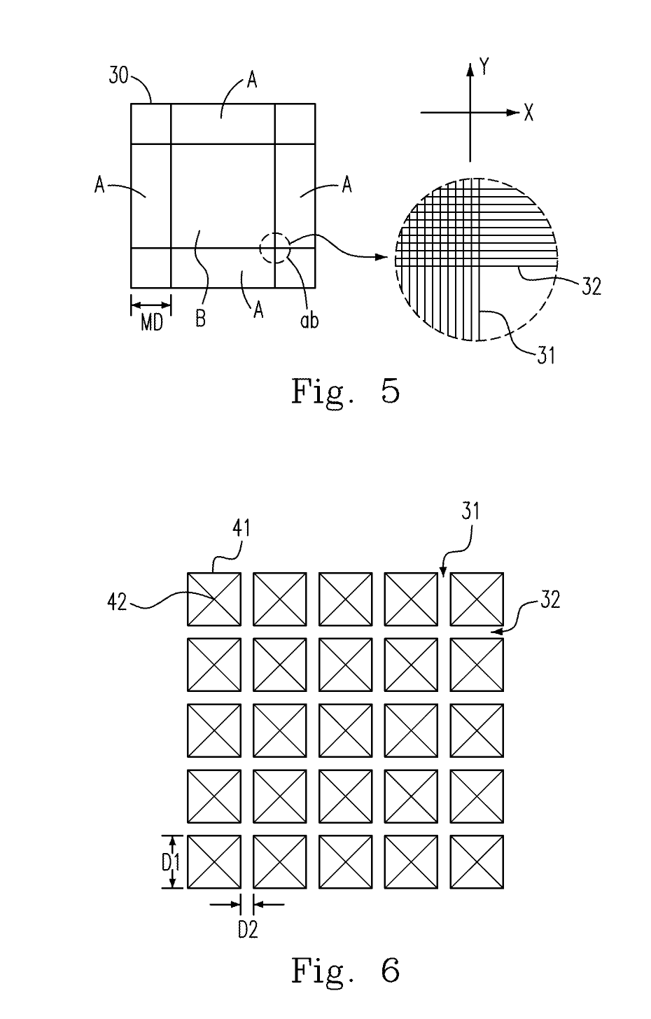

Please refer to FIG. 5, which is a plane view of an imprinting mold formed by the knife 20 in FIG. 4 according to an embodiment of the present invention. After the conductive metal layer 30 on the supporting substrate is processed by the knife 20 along the X direction and the Y direction, a matrix area B and four one-way areas A located outside four sides of the matrix area B are formed on the surface of the conductive metal layer 30. The X direction is perpendicular to the Y direction. According to an embodiment of the present invention, the knife 20 does not cut through the conductive metal layer 30. Therefore, the microstructures formed on a working surface 11 of the supporting substrate 10 are connected to each other. Partially enlarging the area ab at the joint of the matrix area B and two one-way areas A, groove lines 31 cut along the Y direction and groove lines 32 cut along the X direction can be seen. After the conductive metal layer 30 is grinded and polished, the flatness of the peripheral region thereof is worse than that of the intermediate region thereof. In order to avoid using the peripheral region of the conductive metal layer 30 with a worse flatness, the peripheral region of the conductive metal layer 30 has spacings MD.

Please refer to FIG. 6, which is a top view of the microstructures 41 within the matrix area B in FIG. 5. The microstructures 41 are arranged to form a matrix. Each microstructure 41 is a regular square pyramid. That is, four bottom sides of each microstructure 41 have an equal width D1. Please refer to FIG. 8, which is a partial cross-sectional view of the microstructures 41 in FIG. 6. The conductive metal layer 30 is disposed on the supporting substrate 10, and the microstructures 41 are formed on the conductive metal layer 30. Each microstructure 41 presents an isosceles triangle from a side view, and has a vertex 42 and a bottom, wherein the distance between the vertex 42 and the bottom is a height H. Between two adjacent microstructures 41 are the groove lines 31, 32 in FIG. 5. The width of each groove line 31, 32 is D2, which is the distance of the spacing between two adjacent microstructures 41. The width D2 of each groove line 31, 32 is equal to the width D of the plane of the point 21 of the knife 20. An interior angle R1 of the microstructure 41 is equal to the included angle R of the point 21 of the knife 20. Take the silicon substrate on which the gallium nitride is grown as an example, wherein the width D1 of the microstructure 41 is 2.4 μm, the interior angle R1 of the microstructure 41 is 61.97 degrees, the height H is 2 μm, and the width D2 is 0.6 μm.

According to an embodiment of the present invention, the conductive metal layer 30 can be processed by the knife 20 at various different angles to form microstructures with different shapes. For example, the conductive metal layer 30 is processed by the knife 20 along three different directions where there is an included angle of 120 degrees between every two directions. In this way, the microstructure 41 formed is a regular hexagonal cone. In addition, the conductive metal layer 30 can also be processed by the knife 20 along arbitrary directions or a curved direction to form various required shapes of microstructures.

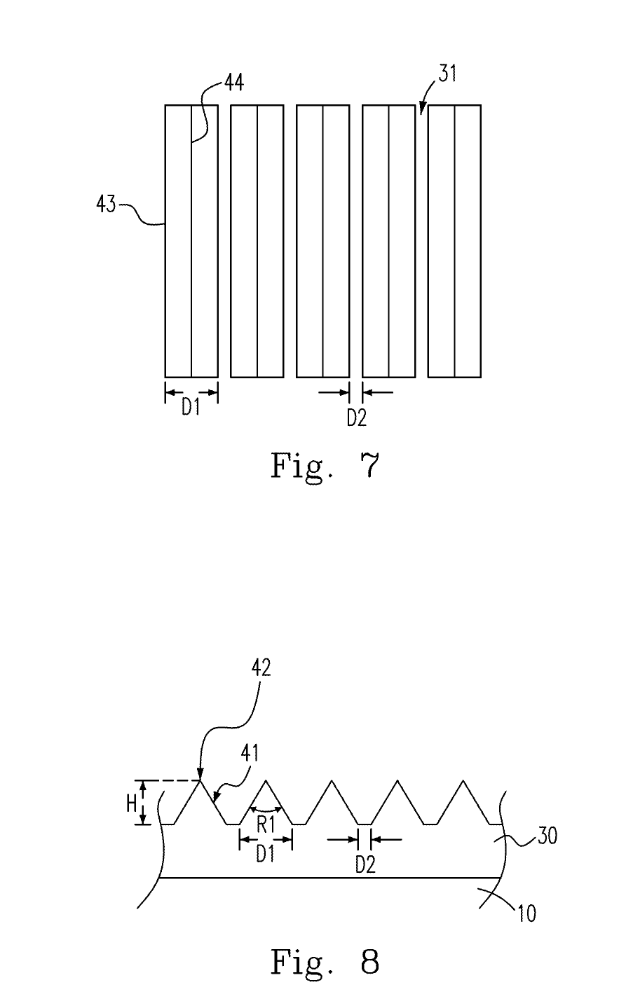

Please refer to FIG. 7, which is top view of microstructures within the one-way area A at the upper side in FIG. 5. Each rectangular microstructure 43 has a major axis direction perpendicular to a corresponding side of the matrix area B, and has a ridgeline 44. Therefore, the shape of the microstructure 43 from a lateral view along the major axis direction is an isosceles triangle (identical to the shape as shown in FIG. 8). The spacing between two adjacent rectangular microstructures 43 form the groove line 31 whose width is D2. The width D2 is equal to the width D of the plane of the point 21 of the knife 20. Take the silicon substrate on which the gallium nitride is grown as an example, wherein the width D1 of the rectangular microstructure 43 is 2.4 μm, and the height thereof is 2 μm.

The silicon substrate manufactured according to the above steps and methods has a plurality of regular quadrangular pyramids arranged as a two-dimensional matrix. The side length of each regular quadrangular pyramid is 2 μm, and the height thereof is also 2 μm. Therefore, the vertex angle of each regular quadrangular pyramid is 61.97 degrees. There is a spacing distance of 0.6 μm between two adjacent regular quadrangular pyramids. Such silicon substrate can significantly reduce the difference in the thermal expansion coefficient between the GaN substrate and the silicon substrate to avoid the problem of thermal deformation. In addition, compared to the sapphire substrate, using the silicon substrate for GaN epitaxy has an excellent cost advantage, thereby effectively reducing the manufacturing cost of the gallium nitride-based blue light-emitting diode.

Moreover, the imprinting mold manufactured according to the present invention has a supporting substrate and a conductive metal layer disposed on the working surface of the supporting substrate. The surface of the conductive metal layer has a plurality of microstructures arranged as a matrix. Certainly, in addition to the above embodiments where the microstructures are formed by the conductive metal layer itself, the microstructures of the present invention can also be formed not by the conductive metal layer itself, instead of by other materials formed on the conductive metal layer. In addition, in order to prevent impurities resulting from the manufacturing process from remaining on the microstructures, the conductive metal layer for forming the microstructures can be cleaned by ultrasonic with acetone or alcohol to remove impurities thereon.

When micro/nano patterning structures are manufactured according to the CNC manner of the present invention, a groove can be repeatedly cut by a knife at different cutting angles or by knives with different shapes to form the microstructure whose sidewalls have plane surfaces or curved surfaces with different slopes. Groove lines can be interlaced with each other at different angles to form different 3D structures such as triangular pyramids, pentagonal pyramids, hexagonal pyramids, etc.

The imprinting mold of the present invention is suitable for the nano imprinting and the electrochemical processing method for mass production of the substrate having patterning structures, and has the advantages of high productivity and a low cost. In addition, the imprinting mold of the present invention can be applied to the glass substrate, the plastic substrate, the silicon substrate, the sapphire substrate or other substrates used by the light-emitting diode industry, e.g. the Gap substrate, the GaAs substrate, the SiC substrate, etc. When the imprinting is performed by the electrochemical processing method, a platinum layer can also be formed on the surface of the conductive metal layer to serve as a catalyzer layer, and a voltage is applied to accelerate the rate of electrochemical etching.

### Embodiments

1. A method of manufacturing an imprinting mold, comprising steps of providing a supporting substrate; forming a conductive metal layer on the supporting substrate; polishing the conductive metal layer to form a polished surface; and treating the polished surface to form a plurality of microstructures.
2. The method of Embodiment 1, further comprising steps of providing a supporting material; processing the supporting material to form a processed material having a predetermined shape; and thermally treating the processed material to form the supporting substrate.
3. The method of any one of Embodiments 1-2, wherein the supporting substrate has a material being one selected from a group consisting of a stainless steel, a mold steel, a carbon steel and an amorphous metal.
4. The method of any one of Embodiments 1-3, wherein the conductive metal layer has a material being a nickel.
5. The method of any one of Embodiments 1-4, wherein the conductive metal layer has a material being a copper.
6. The method of any one of Embodiments 1-5, wherein the microstructures are formed by at least one selected from a group consisting of a computer numerical control (CNC) machine, a focused ion beam (FIB), an electron beam, an x-ray and a laser.
7. An imprinting mold, comprising a supporting substrate; a conductive metal layer disposed on the supporting substrate; and a plurality of microstructures formed on the conductive metal layer.
8. The imprinting mold of Embodiment 7, wherein the microstructures and the conductive metal layer are formed integrally with one another.
9. The imprinting mold of any one of Embodiments 7-8, wherein the microstructures and the conductive metal layer are formed separately.
10. The imprinting mold of any one of Embodiments 7-9, wherein the supporting substrate has a material being one selected from a group consisting of a stainless steel, a mold steel, a carbon steel and an amorphous metal.
11. The imprinting mold of any one of Embodiments 7-10, wherein the conductive metal layer has a material being one of a nickel and a copper.
12. The imprinting mold of any one of Embodiments 7-11, wherein the microstructures are formed by at least one selected from a group consisting of a computer numerical control machine, a focus ion beam, an electron beam, an x-ray and a laser.
13. An imprinting mold, comprising a supporting substrate having a working surface; and a plurality of microstructures formed on the working surface and connected to each other.
14. The imprinting mold of Embodiment 13, wherein the supporting substrate has a material being one selected from a group consisting of a stainless steel, a mold steel, a carbon steel and an amorphous metal.
15. The imprinting mold of any one of Embodiments 13-14, wherein the conductive metal layer has a material being one of a nickel and a copper.
16. The imprinting mold of any one of Embodiments 13-15, wherein the microstructures are formed by at least one selected from a group consisting of a computer numerical control machine, a focus ion beam, an electron beam, an x-ray and a laser.
17. An imprinting mold, comprising a rigid supporting substrate having a working surface; and a plurality of microstructures formed on the working surface and performing an imprinting.
18. The imprinting mold of Embodiment 17, wherein the supporting substrate has a material being one selected from a group consisting of a stainless steel, a mold steel, a carbon steel and an amorphous metal.
19. The imprinting mold of any one of Embodiments 17-18, wherein the conductive metal layer has a material being one of a nickel and a copper.
20. The imprinting mold of any one of Embodiments 17-19, wherein the microstructures are formed by at least one selected from a group consisting of a computer numerical control machine, a focus ion beam, an electron beam, an x-ray and a laser.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method of manufacturing an imprinting mold, comprising steps of:
providing a supporting substrate;
forming a conductive metal layer on the supporting substrate;
polishing the conductive metal layer to form a polished surface; and
treating the polished surface to form a plurality of microstructures.

2. The method as claimed in claim 1, further comprising steps of:
providing a supporting material;
processing the supporting material to form a processed material having a predetermined shape; and
thermally treating the processed material to form the supporting substrate.

3. The method as claimed in claim 1, wherein the supporting substrate has a material being one selected from a group consisting of a stainless steel, a mold steel, a carbon steel and an amorphous metal.

4. The method as claimed in claim 1, wherein the conductive metal layer has a material being a nickel.

5. The method as claimed in claim 1, wherein the conductive metal layer has a material being a copper.

6. The method as claimed in claim 1, wherein the microstructures are formed by at least one selected from a group consisting of a computer numerical control (CNC) machine, a focused ion beam (FIB), an electron beam, an x-ray and a laser.

7. An imprinting mold, comprising:
a supporting substrate;
a conductive metal layer disposed on the supporting substrate; and
a plurality of microstructures formed on the conductive metal layer.

8. The imprinting mold as claimed in claim 7, wherein the microstructures and the conductive metal layer are formed integrally with one another.

9. The imprinting mold as claimed in claim 7, wherein the microstructures and the conductive metal layer are formed separately.

10. The imprinting mold as claimed in claim 7, wherein the supporting substrate has a material being one selected from a group consisting of a stainless steel, a mold steel, a carbon steel and an amorphous metal.

11. The imprinting mold as claimed in claim 7, wherein the conductive metal layer has a material being one of a nickel and a copper.

12. The imprinting mold as claimed in claim 7, wherein the microstructures are formed by at least one selected from a group consisting of a computer numerical control machine, a focus ion beam, an electron beam, an x-ray and a laser.

13. An imprinting mold, comprising:
a supporting substrate having a working surface; and
a plurality of microstructures formed on the working surface and connected to each other.

14. The imprinting mold as claimed in claim 13, wherein the supporting substrate has a material being one selected from a group consisting of a stainless steel, a mold steel, a carbon steel and an amorphous metal.

15. The imprinting mold as claimed in claim 13, wherein the conductive metal layer has a material being one of a nickel and a copper.

16. The imprinting mold as claimed in claim 13, wherein the microstructures are formed by at least one selected from a group consisting of a computer numerical control machine, a focus ion beam, an electron beam, an x-ray and a laser.

17. An imprinting mold, comprising:
a rigid supporting substrate having a working surface; and
a plurality of microstructures formed on the working surface and performing an imprinting.

18. The imprinting mold as claimed in claim 17, wherein the supporting substrate has a material being one selected from a group consisting of a stainless steel, a mold steel, a carbon steel and an amorphous metal.

19. The imprinting mold as claimed in claim 17, wherein the conductive metal layer has a material being one of a nickel and a copper.

20. The imprinting mold as claimed in claim 17, wherein the microstructures are formed by at least one selected from a group consisting of a computer numerical control machine, a focus ion beam, an electron beam, an x-ray and a laser.
